(19) United States
(12) Patent Application Publication
(10) Pub. No.: US 2024/0010958 A1
(43) Pub. Date: Jan. 11, 2024

(54) Washing Agent Tablet

(71) Applicant: Henkel AG & Co. KGaA, Duesseldorf (DE)

(72) Inventors: Matthias Sunder, Duesseldorf (DE); Niklas Matzeit, Bergheim (DE); Marouane Jaafour, Duesseldorf (DE); Mareile Job, Leverkusen (DE); Till Frey, Duesseldorf (DE)

(73) Assignee: Henkel AG & Co. KGaA, Duesseldorf (DE)

(21) Appl. No.: 18/472,673

(22) Filed: Sep. 22, 2023

Related U.S. Application Data
(63) Continuation of application No. PCT/EP2022/050665, filed on Jan. 13, 2022.

(30) Foreign Application Priority Data
Mar. 23, 2021 (EP) 21164423.2

(51) Int. Cl. C11D 17/00; C11D 3/22; C11D 3/12

(52) U.S. Cl. CPC C11D 17/0078; C11D 3/222; C11D 3/128; C11D 3/1233

(57) ABSTRACT

The present invention relates to a washing agent tablet having a printable phase made of a compressed particulate premixture, wherein the particulate premixture has a particle size distribution in which at least 60 wt. % of the particles have a particle size of between 100 μm and 900 μm, and at least 90% of the surface of the printable phase outside the printed region has a degree of whiteness which is defined by L*ₘₐₓ, a*ₘₐₓ, and b*ₘₐₓ.

### FIELD OF THE INVENTION

The present invention relates to washing agent tablets. In particular, the present invention relates to printed washing agent tablets having specific surface properties, washing agent product forms which comprise these washing agent tablets, and washing and cleaning methods using these washing agent tablets.

### BACKGROUND OF THE INVENTION

Continuously changing requirements are placed on the forms of manufacture and supply of washing and cleaning agents. The main focus has, for quite some time, been on the convenient dosing of washing agents and cleaning agents by the consumer and the simplification of the work steps necessary for carrying out a washing or cleaning method. One technical solution is provided by pre-portioned washing or cleaning agents, for example, water-soluble containers having one or more receiving compartments for powdered or liquid washing agents or cleaning agents. A further technical solution is provided by washing agent tablets which have a single-phase or multi-phase design.

Just like the water-soluble containers, the washing agent tablets typically have wrappings made of film materials, which, in the case of the washing agent tablets, can be water-soluble or water-insoluble, however, wherein the water-insoluble film packaging must be removed by the consumer before the washing agent tablet is used.

Water-soluble and water-insoluble film packaging give the manufacturers of corresponding dosing units the option of providing the washing or cleaning agents with imprints, such as product names, product information, company names or advertising messages and symbols. In the case of the washing agent tablets, these advantageous properties of the film packaging are disadvantageously offset by an increased consumption of packaging materials. Water-soluble packaging films, which are not removed by the consumer before use of the washing agent tablets, additionally delay the dissolution of the tablets and, in particular in short or cold washing processes, reduce their product performance.

### BRIEF DESCRIPTION OF THE INVENTION

Against the background of the prior art described above, the object of the application was that of providing washing agent portion units that can be produced by means of simplified methods, have high product and storage stability, can be prepared in a simple manner using minimal amounts of additional packaging materials, and appeal to the consumer with an attractive olfactory, visual, and/or tactile experience. Finally, the washing agent portion units should have a high product performance and be easy and safe to handle for the consumer.

### DETAILED DESCRIPTION OF THE INVENTION

A washing agent tablet having a printable phase made of a compressed particulate premixture is suitable for achieving these objects, wherein,
the particulate premixture has a particle size distribution in which at least 60 wt. % of the particles have a particle size between 100 μm and 900 μm;
at least 90% of the surface of the printable phase outside the printed region has a degree of whiteness which is defined by
L*ₘₐₓ is in the range of from 85 to 100,
a*ₘₐₓ is in the range of from −3 to +5,
b*ₘₐₓ is in the range of from +5 to −15.

Surprisingly, it has been found that both the particle size distribution of the particulate premixture used for producing the tablet and the degree of whiteness of the tablets produced from this premixture influence the perceptibility and durability of the print. With respect to the particle size distribution, both the absolute size of the particles and the proportion by weight of particles of a certain size have an influence.

For the reasons mentioned above, it is therefore preferred that the particulate premixture has a particle size distribution in which at least 70 wt. % of the particles, preferably at least 80 wt. % of the particles and in particular at least 90 wt. % of the particles have a particle size between 100 μm and 900 μm. It is further preferred for the particulate premixture to have a particle size distribution in which at least 60 wt. % of the particles have a particle size between 200 μm and 800 μm, preferably between 250 μm and 750 μm.

Good print results were observed for particulate premixtures having a bimodal particle size distribution with maxima in the range between 100 μm and 900 μm.

The degree of whiteness of the tablet surface has proven to be particularly relevant for the perceptibility and legibility of the print.

For this reason, washing agent tablets are preferred, wherein at least 90%, preferably at least 95% and in particular at least 98% of the surface of the printable phase outside the printed region has a degree of whiteness which is defined by
L*ₘₐₓ is in the range of from 85 to 100,
a*ₘₐₓ is in the range of from −3 to +5,
b*ₘₐₓ is in the range of from +5 to −15.

Further preferred are washing agent tablets, wherein at least 90%, preferably at least 95% and in particular at least 98% of the surface of the printable phase outside the printed region has a degree of whiteness which is defined by
L*ₘₐₓ is in the range of from 95 to 100,
a*ₘₐₓ is in the range of from −1 to +2,
b*ₘₐₓ is in the range of from +2 to −4.

Particularly preferred are washing agent tablets, wherein at least 90%, preferably at least 95% and in particular at least 98% of the surface of the printable phase outside the printed region has a degree of whiteness which is defined by,
L*ₘₐₓ is in the range of from 98 to 100,
a*ₘₐₓ is in the range of from −1 to +1,
b*ₘₐₓ is in the range of from +1 to −1.

Very particularly preferred are washing agent tablets, wherein at least 90%, preferably at least 95% and in particular at least 98% of the surface of the printable phase outside the printed region has a degree of whiteness which is defined by,
L*ₘₐₓ is in the range of from 99 to 100,
a*ₘₐₓ is in the range of 0,
b*ₘₐₓ is in the range of 0.

The term phase denotes a macroscopic region of the washing agent tablet which preferably comprises at least 5 vol. %, preferably at least 15 vol. % and in particular at least 25 vol. % of the washing agent tablet. Exemplary phases are tablet layers.

In a preferred embodiment, the washing agent tablet has two or more layers. While the production of the tablets tends to become more complex with an increasing number of layers, a tablet design having two or more layers simultaneously expands the degrees of freedom with respect to the particle sizes and the degree of whiteness of the constituents used in the washing agent tablet, since the particle sizes and the degree of whiteness in the non-printed layers may differ from the particle sizes and degree of whiteness of the printed layer.

In a preferred embodiment, the washing agent tablet has two layers which differ with respect to their average particle size D50, and the layer having the lower average particle size D50 has a printed portion.

In a further preferred embodiment, the washing agent tablet has two layers which differ with respect to their degree of whiteness, and the layer having the higher degree of whiteness has a printed portion.

With regard to the technical realization of the degree of whiteness according to the invention, a number of different procedures are available to the person skilled in the art, which can be used alone or in combination to adjust the degree of whiteness.

These technical measures include, for example:
using preferably particulate constituents having suitable degrees of whiteness;
using pigments, in particular white pigments;
selecting a suitable particle size and particle size distribution of the premixture to be tableted;
selecting a suitable pressing pressure for tableting the particulate premixture;
setting a suitable surface roughness of the tablet outer surface.

The group of the constituents of the particulate premixture that are preferred due to their degree of whiteness includes, in particular, inorganic and organic salts. The group of preferred inorganic salts includes, in particular, sodium carbonate, sodium percarbonate, sodium hydrogencarbonate, sodium sulfate, sodium silicate and zeolite. A preferred organic salt is sodium citrate. Preference is furthermore given to the use of urea.

Preferred particulate premixtures comprise, based on the total weight thereof, substances from the group of sodium carbonate, sodium percarbonate, sodium hydrogencarbonate, sodium sulfate, sodium silicate, zeolite, sodium citrate and urea in amounts above 40 wt. %, preferably above 50 wt. % and in particular from 55 to 70 wt. %.

The pigments with which the degree of whiteness of the tablet surface can be improved include, for example, calcium carbonate, titanium dioxide, which may be present in rutile or anatase crystal modification, zinc oxide, zinc sulfide, white lead (basic lead carbonate), barium sulfate, aluminum hydroxide, antimony oxide, lithopone (zinc sulfide barium sulfate), kaolin, chalk, talc and/or mica. Typically, the average particle size of such pigments is in the range of from 0.004 μm to 50 μm. The use of pigments that have been surface modified with dispersing agents is also possible. Preferably, titanium dioxide pigment which is surface modified with Al, Si, Zr or polyol compounds is used, in particular in rutile form, as is marketed, for example, under the trade names Kronos® 2132 (Kronos-Titan) or Hombitan® R 522 (Sachtleben Chemie GmbH). The Tiona® RLL, AG or VC types from Solvay, as well as the BayerTitan® RD, R-KB and AZ types from Bayer AG, can also be used.

Stearates, in particular calcium stearate, magnesium stearate and strontium stearate form another group of suitable white pigments. Like the aforementioned white pigments, these white pigments can also be added to the particulate premixture before tableting. Alternatively, however, it is also possible to apply the white pigments, in particular the stearates, to the tablet surface during or after tableting. This is achieved, for example, by applying the stearate to the die surface, wherein the stearate is transferred to the tablet surface during tableting, or by removing or coating the tablet surface after tableting. The use of calcium stearate and magnesium stearate is particularly preferred as a coating or powder agent.

The white pigments described above are preferably used in amounts of 0.001 to 0.8 wt. %, particularly preferably of 0.01 to 0.6 wt. %, based on the total weight of the particulate premixture. The use of these white pigments in washing agent tablets containing washing or cleaning active enzymes is particularly preferred, since these enzymes can cause an undesired coloring of the washing agent tablet surface. The white pigments can be added to the particulate premixture as an integral constituent of the enzyme granulate or as a separate active ingredient.

The particle size distribution of the particulate premixture, in which at least 60 wt. % of the particles have a particle size between 100 μm and 900 μm, also advantageously influences the degree of whiteness of the tablet while at the same time providing sufficient tablet integrity. While, in the case of a given tableting pressure, larger particles typically lower the degree of whiteness, the use of smaller particles increases the abrasion during production and transport.

The washing agent tablets are preferably obtained by tableting the particulate premixtures with low pressing pressures. These low pressing pressures correlate to tablet hardnesses of preferably 50 N to 300 N and in particular 70 N to 200 N. The hardness of the tablets is measured by deformation of the tablet until fracture, wherein the force acts on the lateral surfaces of the tablet and the maximum force that the tablet withstands is determined. In order to determine the level of tablet hardness, a tablet testing apparatus from the company Sotax is suitable, for example. Although, in the case of a given premixture, a higher degree of whiteness of the tablet surface is typically achieved as a result of the smoother tablet surface caused by the use of higher pressing pressures, said high pressing pressures have an undesired adverse effect on the disintegration of the tablet as a result of the tablet hardness, which is likewise increased. The aforementioned tablet hardnesses of preferably 50 N to 300 N and in particular 70 N to 200 N are accompanied by a sufficiently rapid tablet decomposition with, at the same time, an advantageous degree of whiteness.

An average roughness of at least one outer surface of the tablet of 25 μm to 500 μm, preferably of 50 μm to 300 μm, has also proven advantageous for the desired degree of whiteness with, at the same time, good printability. Roughness describes the deviation of a real surface from an ideally smooth surface and is determined, for example, by means of confocal laser scanning microscopy. The printed region of the washing agent tablet preferably has an average roughness of 25 μm to 500 μm, preferably of 50 μm to 300 μm.

Printing using an inkjet printer has proven to be particularly advantageous for the technical implementation of the printing and the durability of the printed images obtained. The print resolution is preferably 120 to 360 dpi and in particular 180 to 300 dpi.

Preferably 20% to 60%, in particular 25% to 45% of the surface of the printable phase is printed. Print motifs with curved contours have proven to be particularly suitable.

For reasons of better perceptibility and identifiability, the printed surface, and the surface of the printable phase outside the printed region have a color difference ΔE above 20, preferably above 40 and in particular above 60.

Washing agent tablets refer both to product forms for textile laundry and to product forms for cleaning hard surfaces, such as ceramics, glass, metal, or tiles. The washing agent tablets preferably have a weight of 14 g to 42 g, preferably of 20 g to 38 g, in particular of 24 g to 34 g.

Preferred washing agent tablets are cuboidal. Due to their manufacturability and their properties relating to removal from the outer packaging, washing agent shaped bodies which have a flat lower face, the largest diagonal of which is more than twice, preferably more than four times the height of the washing agent shaped bodies, are preferred.

The cuboidal washing agent tablets comprise a lower face, an upper face and a lateral face connecting the lower face and the upper face. It has also proven advantageous for the stability of the tablets if the edges delimiting the lower face and the upper face are chamfered. To increase the stability of the shaped bodies, it may also be appropriate to round off the edges of the lateral faces connecting the lower faces and the upper faces.

The density of preferred washing agent tablets is 1.1 g/cm³ to 1.5 g/cm³, preferably 1.15 g/cm³ to 1.3 g/cm³. As a consequence of the high density of the shaped bodies and the high fill level, the washing agent product forms according to the invention and described below have comparatively high densities, for example densities in the range of from 0.9 g/cm³ to 1.4 g/cm³, preferably in the range of from 1.05 g/cm³ to 1.3 g/cm³.

The incorporation of specific active ingredients into the washing agent tablet has proven advantageous for contour sharpness and the durability of the printed image. For this reason, preference is given to washing agent tablets containing at least one active ingredient from the group of builders, in particular at least one active ingredient from the group of zeolites, silicates and carbonates, preferably from the group of zeolites. The proportion by weight of said active ingredients with respect to the total weight of the washing agent tablet is preferably 5 to 60 wt. %, in particular 10 to 50 wt. %. Washing agent tablets which contain, based on the total weight thereof, 5 to 60 wt. %, in particular 10 to 50 wt. % of zeolite are particularly preferred.

The use of an active ingredient from the group of celluloses and cellulose derivatives, preferably from the group of celluloses, microcrystalline celluloses and carboxymethyl celluloses, is also advantageous for the contour sharpness and durability of the printed image. The proportion by weight of said cellulose-based active ingredients with respect to the total weight of the washing agent tablet is preferably 2 to 50 wt. %.

To improve the printed image, preferred washing agent tablets contain, based on the total weight thereof, less than 10 wt. %, preferably less than 5 wt. %, and in particular less than 1 wt. % of an organic acid. Organic acid refers to active ingredients that are contained in the washing agent tablets in acid form, i.e., not in the form of the salt thereof.

The washing agent tablets are preferably obtained by tableting the particulate premixtures with low pressing pressures. These low pressing pressures correlate to tablet hardnesses of preferably 50 N to 300 N and in particular 70 N to 200 N. The hardness of the tablets is measured by deformation of the tablet until fracture, wherein the force acts on the lateral surfaces of the tablet and the maximum force that the tablet withstands is determined. In order to determine the level of tablet hardness, a tablet testing apparatus from the company Sotax is suitable, for example.

As stated above, preferred washing agent tablets have at least one rough outer surface with an average roughness of from 25 μm to 500 μm, preferably of from 50 μm to 300 μm. Roughness describes the deviation of a real surface from an ideally smooth surface and is determined, for example, by means of confocal laser scanning microscopy. The printed region of the washing agent tablet preferably has an average roughness of 25 μm to 500 μm, preferably of 50 μm to 300 μm. The roughness values preferred according to the invention reduce the abrasion of the shaped bodies during production and transport and have an advantageous effect on the durability of the print.

Packaging the washing agent tablets in film packaging is also advantageous for the durability of the print. Washing agent tablets having a separate film packaging are particularly preferred in this case.

If film packagings are used, film packagings made of a water-soluble film material are preferred. The water-soluble film material may comprise one or more structurally different water-soluble polymer(s). Suitable water-soluble polymer(s) are in particular polymers from the group of (optionally acetalized) polyvinyl alcohols (PVAL) and copolymers thereof.

Water-soluble film materials are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The production of the polyvinyl alcohol and polyvinyl alcohol copolymers generally includes the hydrolysis of intermediate polyvinyl acetate. Preferred polyvinyl alcohols and polyvinyl alcohol copolymers have a degree of hydrolysis of 70 to 100 mol. %, preferably 80 to 90 mol. %, particularly preferably 81 to 89 mol. %, and in particular 82 to 88 mol. %.

Preferred polyvinyl alcohol copolymers comprise, in addition to vinyl alcohol, an ethylenically unsaturated carboxylic acid, or the salt or ester thereof. In addition to vinyl alcohol, such polyvinyl alcohol copolymers particularly preferably contain sulfonic acids, such as 2-acrylamido-2-methyl-1-propanesulfonic acid (AMPS), acrylic acid, methacrylic acid, acrylic esters, methacrylic esters or mixtures thereof; among the esters, preference is given to C1-4 alkyl esters or C1-4 hydroxyalkyl esters. Ethylenically unsaturated dicarboxylic acids, for example itaconic acid, maleic acid, fumaric acid and mixtures thereof, are possible as further monomers.

Due to their availability, easy processability and biodegradability, film packagings that consist of at least 40 wt. %, preferably at least 60 wt. % and in particular at least 80 wt. % of polyvinyl alcohol are preferred.

In order to increase the stability of the shaped bodies and to ensure a sufficient fill level in the outer packaging, it is preferred to shrink the film packaging onto the washing agent tablets.

Despite the aforementioned technical advantages, for reasons of sustainable production and packaging of the washing agent tablets, it may be preferred if the tablets do not have a separate film packaging, in particular no film packaging made of a water-soluble film material.

This application therefore further relates to a washing agent product form comprising
a) washing agent tablets having a printable phase according to the invention
b) an outer packaging in the form of a folding box, having a bottom surface, a top surface and side walls connecting the bottom surface and the top surface, wherein
i) the outer packaging has a fill level of 85 vol. % to 99 vol. %, and
ii) the outer packaging contains at least two washing agent tablets which are arranged in the outer packaging in a sorted manner.

The outer packaging is preferably designed as a single piece folding box. Preferred outer packagings have a flat bottom surface, the largest diagonal of which is greater than the height of the outer packaging. This design of the outer packaging increases its stability and enables simple opening and removal. It is particularly preferred if the outer packaging has a flat bottom surface, the largest diagonal of which is more than twice, preferably more than four times the height of the outer packaging.

To achieve the high fill level, it has proven advantageous for the outer packaging to have an angular bottom surface, preferably a quadrilateral bottom surface, very particularly preferably a rectangular bottom surface. For the same reason and for improving the stackability of the outer packagings, it is preferred that the outer packaging has a top surface that is plane-parallel to the bottom surface. Outer packagings in cuboid form are particularly preferred.

For increasing storage stability, in particular the chemical stabilization of the washing agent shaped bodies, it has proven advantageous for the outer packaging to be reclosable. Suitable closure elements are, for example, adhesive, latching, snapping or plug-in elements, wherein adhesive and plug-in elements are particularly preferred. Exemplary closure elements are plug-in closures or removable adhesive closures.

For reasons of sustainability, recycled and/or recyclable materials are preferred for the production of the outer packaging. The packaging materials are preferably based on renewable raw materials. The use of packaging materials based on pulp and wastepaper is particularly preferred.

In a first preferred embodiment, the outer packaging is made of cardboard. In addition to its availability and recyclability, the advantages of cardboard lie in the great variability of available types and grammages. Preferred cardboards have a grammage of 150 to 400 g/m².

In a particularly preferred embodiment the corrugated cardboard, which has proven to be technically superior to cardboard in some respects, is used for manufacturing the outer packaging. Corrugated cardboard is characterized by a high strength with low net weight and is a suitable means for storage and transportation even in large containers.

In a particularly preferred embodiment, the outer packaging is designed as a box having a hinged lid.

An essential feature of the washing agent product form according to the invention is its high fill level of 85 to 99 vol. % of the outer packaging. This high fill level not only reduces the amount of packaging material that can be used for each washing agent shaped body, but surprisingly also increases the physical stability of the washing agent shaped bodies, not only with regard to fracturing of the shaped body but also with respect to abrasion of the shaped body and the durability of the print. The fill level of preferred outer packagings is 88 vol. % and 99 vol. %, preferably 92 vol. % and 99 vol. %. The term “fill level” refers to the proportion of the internal volume of the outer packaging that is taken up by the washing agent shaped bodies in the outer packaging.

In order to reduce the proportion of packaging per washing agent shaped body, it is preferred if the washing agent product form comprises at least ten, preferably at least twenty, particularly preferably at least thirty, washing agent shaped bodies which are arranged in the outer packaging in a sorted manner.

In the case of integration of a larger number of washing agent shaped bodies into the washing agent product form, the stability of the shaped bodies can be further improved by a targeted arrangement of the shaped bodies. Washing agent product forms which comprise at least ten, preferably at least twenty, particularly preferably at least thirty, washing agent shaped bodies, which are arranged in the outer packaging in a sorted manner such that each of the washing agent shaped bodies is in direct contact with at least three other washing agent shaped bodies, have proven to be advantageous.

A third subject matter of this application is a method for producing a printed washing agent tablet according to the invention, comprising the steps of
a) providing a particulate premixture
b) pressing the particulate premixture to form a washing agent tablet
c) printing the resulting washing agent tablet.

As stated above, the washing agent tablets according to the invention are suitable for cleaning textiles as well as for cleaning hard surfaces. Further subjects of the application are therefore methods for textile care or textile cleaning, in which a printed washing agent tablet according to the invention is introduced into the dosing chamber or the washing drum of a textile washing machine, and methods for dishwashing, in which a printed washing agent tablet according to the invention is introduced into the dosing chamber or the interior of a dishwasher. Preferred washing or cleaning methods are carried out at liquor temperatures below 40° C.

In summary, the following subjects, inter alia, are provided by this application:
1. A printed washing agent tablet having a printable phase made of a compressed particulate premixture, wherein
   the particulate premixture has a particle size distribution in which at least 60 wt. % of the particles have a particle size between 100 μm and 900 μm;
   at least 90% of the surface of the printable phase outside a printed region has a degree of whiteness which is defined by
   L*ₘₐₓ is in the range of from 85 to 100,
   a*ₘₐₓ is in the range of from −3 to +5,
   b*ₘₐₓ is in the range of from +5 to −15.
2. The washing agent tablet according to point 1, wherein the particulate premixture has a particle size distribution in which at least 70 wt. % of the particles, preferably at least 80 wt. % of the particles and in particular at least 90 wt. % of the particles have a particle size between 100 μm and 900 μm.
3. The washing agent tablet according to one of the preceding points, wherein the particulate premixture has a particle size distribution in which at least 60 wt. % of the particles have a particle size between 200 μm and 800 μm, preferably between 250 μm and 750 μm.
4. The washing agent tablet according to one of the preceding points, wherein the particulate premixture has a bimodal particle size distribution with maxima in the range between 100 μm and 900 μm.
5. The washing agent tablet according to one of the preceding points, wherein at least 90%, preferably at least 95% and in particular at least 98% of the surface of the printable phase outside the printed region has a degree of whiteness defined by
L*ₘₐₓ is in the range of from 85 to 100,
a*ₘₐₓ is in the range of from −3 to +5,
b*ₘₐₓ is in the range of from +5 to −15.
6. The washing agent tablet according to one of the preceding points, wherein at least 90%, preferably at least 95% and in particular at least 98% of the surface of the printable phase outside the printed region has a degree of whiteness defined by
L*ₘₐₓ is in the range of from 95 to 100,
a*ₘₐₓ is in the range of from −1 to +2,
b*ₘₐₓ is in the range of from +2 to −4.
7. The washing agent tablet according to one of the preceding points, wherein at least 90%, preferably at least 95% and in particular at least 98% of the surface of the printable phase outside the printed region has a degree of whiteness defined by
L*ₘₐₓ is in the range of from 98 to 100,
a*ₘₐₓ is in the range of from −1 to +1,
b*ₘₐₓ is in the range of from +1 to −1.
8. The washing agent tablet according to one of the preceding points, wherein at least 90%, preferably at least 95% and in particular at least 98% of the surface of the printable phase outside the printed region has a degree of whiteness defined by
L*ₘₐₓ is in the range of from 99 to 100,
a*ₘₐₓ is in the range of 0,
b*ₘₐₓ is in the range of 0.
9. The washing agent tablet according to one of the preceding points, wherein the washing agent tablet has at least one rough outer surface with an average roughness of from 25 μm to 500 μm, preferably of from 50 μm to 300 μm.
10. The washing agent tablet according to one of the preceding points, wherein the washing agent tablet has an average roughness of from 25 μm to 500 μm, preferably of from 50 μm to 300 μm in the printed region.
11. The washing agent tablet according to one of the preceding points, wherein the washing agent tablet has a tablet hardness of from 50 N to 300 N and in particular of from 70 N to 200 N.
12. The washing agent tablet according to one of the preceding points, wherein the particulate premixture, based on the total weight thereof, comprises substances from the group of sodium carbonate, sodium percarbonate, sodium hydrogencarbonate, sodium sulfate, sodium silicate, zeolite, sodium citrate and urea in amounts above 40 wt. %, preferably above 50 wt. % and in particular from 55 to 70 wt. %.
13. The washing agent tablet according to one of the preceding points, wherein the particulate premixture comprises a white pigment from the group of titanium dioxide, which can be present in rutile or anatase crystal modification, calcium carbonate, zinc oxide, zinc sulfide, white lead (basic lead carbonate), barium sulfate, aluminum hydroxide, antimony oxide, lithopone (zinc sulfide barium sulfate), kaolin, chalk, talc and/or mica, preferably from the group titanium dioxide, which can be present in rutile or anatase crystal modification.
14. The washing agent tablet according to one of the preceding points, wherein the particulate premixture comprises a white pigment from the group of calcium stearate, magnesium stearate and strontium stearate, in particular calcium stearate and magnesium stearate.
15. The washing agent tablet according to one of the preceding points, wherein the surface of the washing agent tablet is powder coated or coated with a white pigment, preferably a white pigment from the group of calcium stearate, magnesium stearate and strontium stearate, in particular calcium stearate and magnesium stearate.
16. The washing agent preparation according to one of the preceding points, wherein the particulate premixture comprises, based on the total weight thereof, a white pigment in amounts of from 0.001 to 0.8 wt. %, preferably from 0.01 to 0.6 wt. %.
17. The washing agent tablet according to one of the preceding points, wherein the particulate premixture comprises an enzyme and white pigment.
18. The washing agent table according to one of the preceding points, wherein the washing agent tablet has two layers.
19. The washing agent tablet according to one of the preceding points, wherein the washing agent tablet has two layers which differ with respect to their average particle size D50, and the layer having the lower average particle size D50 has a printed portion.
20. The washing agent tablet according to one of the preceding points, wherein the washing agent tablet has two layers which differ with respect to their whiteness, and the layer having the higher degree of whiteness has a printed portion.
21. The washing agent tablet according to one of the preceding points, wherein the print was applied by means of an inkjet printer.
22. The washing agent tablet according to one of the preceding points, wherein the print was applied with a print resolution of from 120 to 360 dpi, preferably of from 180 to 300 dpi.
23. A washing agent tablet according to one of the preceding points, wherein the print covers 20% to 60%, preferably 25% to 45%, of the printed phase.
24. The washing agent tablet according to one of the preceding points, wherein the print has a curved contour.
25. The washing agent tablet according to one of the preceding points, wherein the printed surface and the surface of the printable phase outside the printed region have a color difference ΔE above 20, preferably above 40 and in particular above 60.
26. The washing agent tablet according to one of the preceding points, wherein the washing agent tablet has a cuboidal three-dimensional shape.
27. The washing agent tablet according to one of the preceding points, wherein the washing agent tablet has a weight of from 14 g to 42 g, preferably of from 20 g to 38 g and in particular of from 24 g to 34 g.
28. The washing agent tablet according to one of the preceding points, wherein the washing agent tablet has a density between 1.1 g/cm³ and 1.5 g/cm³, preferably between 1.15 g/cm³ and 1.3 g/cm³.
29. The washing agent tablet according to one of the preceding points, wherein the washing agent tablet comprises at least one active ingredient from the group of builders, in particular at least one active ingredient from the group of zeolites, silicates and carbonates, preferably from the group of zeolites.
30. The washing agent tablet according to one of the preceding points, wherein the washing agent tablet, based on the total weight thereof, comprises at least one active ingredient from the group of builders, in particular at least one active ingredient from the group of zeolites, silicates and carbonates, preferably from the group of zeolites in proportions by weight of from 5 to 60 wt. %, preferably of from 10 to 50 wt. %.
31. The washing agent tablet according to one of the preceding points, wherein the washing agent tablet comprises at least one active ingredient from the group of celluloses and cellulose derivatives, preferably from the group of celluloses, microcrystalline celluloses and carboxymethyl celluloses.
32. The washing agent tablet according to one of the preceding points, wherein the washing agent tablet, based on the total weight thereof, comprises at least one active ingredient from the group of celluloses and cellulose derivatives, preferably from the group of celluloses, microcrystalline celluloses and carboxymethyl celluloses in proportions by weight of from 2 to 50 wt. %.
33. The washing agent tablet according to one of the preceding points, wherein the washing agent tablet, based on the total weight thereof, contains less than 10 wt. %, preferably less than 5 wt. %, and in particular less than 1 wt. % of an organic acid.
34. The washing agent tablet according to one of the preceding points, wherein the washing agent tablet has a film packaging.
35. The washing agent tablet according to one of the preceding points, wherein the washing agent tablet has a separate film packaging.
36. The washing agent tablet according to one of the preceding points, wherein the washing agent tablet has a film packaging made of a water-soluble film material.
37. The washing agent tablet according to one of the preceding points, wherein the washing agent tablet has a film packaging consisting of at least 40 wt. %, preferably at least 60 wt. %, and in particular at least 80 wt. % of polyvinyl alcohol.
38. The washing agent tablet according to one of the preceding points, wherein the washing agent tablet has a film packaging which is shrunk onto the washing agent shaped body.
39. The washing agent tablet according to one of the preceding points, wherein the washing agent tablet does not have any film packaging.
40. A washing agent product form, comprising
a) washing agent tablets having a printable phase according to one of points 1 to 39
b) an outer packaging in the form of a folding box, having a bottom surface, a top surface and side walls connecting the bottom surface and the top surface, wherein
i) the outer packaging has a fill level of 85 vol. % to 99 vol. %, and
ii) the outer packaging contains at least two washing agent tablets which are arranged in the outer packaging in a sorted manner.
41. The washing agent product form according to point 40, wherein the outer packaging has a cuboidal shape.
42. The washing agent product form according to one of points 40 or 41, wherein the outer packaging can be reclosed.
43. The washing agent product form according to one of points 40 to 42, wherein the outer packaging is made of cardboard.
44. The washing agent product form according to one of points 40 to 43, wherein the outer packaging is made of corrugated cardboard.
45. The washing agent product form according to one of points 40 to 44, wherein the outer packaging has a fill level of 88 vol. % to 99 vol. %, preferably 92 vol. % to 99 vol. %.
46. The washing agent product form according to one of points 40 to 45, wherein the washing agent product form comprises at least ten, preferably at least twenty, particularly preferably at least thirty, washing agent tablets.
47. The washing agent product form according to one of the preceding points, wherein the washing agent product form comprises at least ten, preferably at least twenty, particularly preferably at least thirty, washing agent tablets, which are arranged in the outer packaging in a sorted manner, such that each of the washing agent tablets is in direct contact with at least three other washing agent tablets.
48. A method for producing a printed washing agent tablet according to one of the preceding points, comprising the steps of:
a) providing a particulate premixture
b) pressing the particulate premixture to form a washing agent tablet
c) printing at least one phase of the resulting washing agent tablet.
49. A method for textile care or textile cleaning, in which a washing agent tablet according to one of points 1 to 39 is introduced into the dosing chamber or the washing drum of a textile washing machine.
50. A method for dishwashing, in which a washing agent tablet according to one of points 1 to 32 is introduced into the dosing chamber or the interior of a dishwasher.
51. The method according to one of points 49 or 50, wherein the method is carried out at liquor temperatures below 4011.

### Example

Particle-shaped premixtures of the composition given in the table below were pressed to form single-phase tablets with a hardness of 70 N to 200 N in a rotary tablet press (values in wt. % based on the particulate premixture). 90 wt. % of the particles of the particulate premixture had a particle size between 100 μm and 900 μm.

| | E1 | E2 | E3 | E4 |
|---|---|---|---|---|
| Anionic surfactant | 18 | 18 | 18 | 18 |
| Soap | 0.4 | 0.4 | 0.4 | 0.4 |
| Non-ionic surfactant | 1.0 | 1.0 | 1.0 | 1.0 |
| Sodium carbonate | 18 | 18 | 13 | 13 |
| Sodium percarbonate | — | — | 16 | 16 |
| Sodium | 6.0 | 6.0 | — | — |
| hydrogencarbonate | | | | |
| Sodium silicate | 3.2 | 3.2 | 2.5 | 2.5 |
| Zeolite | 12.2 | 12.2 | 12.2 | 12.2 |
| Sodium sulfate | 2.5 | 2.5 | 2.5 | 2.5 |
| Sodium citrate | 5.0 | 5.0 | 2.8 | 2.8 |
| Urea | 11 | 11 | 11 | 11 |
| Washing-active polymers | 3.2 | 3.2 | 3.7 | 3.7 |
| Tablet disintegrants | 7.8 | 7.8 | 7.2 | 7.2 |
| (cellulose) | | | | |
| Enzyme preparation | — | 0.4 | — | 0.4 |
| Titanium dioxide | — | 0.08 | — | 0.08 |
| Water | 4.9 | 4.9 | 4.9 | 4.9 |
| Further constituents | To make | To make | To make | To make |
| | up to 100 | up to 100 | up to 100 | up to 100 |

The resulting washing agent tablets had a degree of whiteness on their surface, in which L*ₘₐₓ is in the range of from 98 to 100, a*ₘₐₓ is in the range of from −1 to +1 and b*ₘₐₓ is in the range of from +1 to −1.

The washing agent tablets were printed with a symbol (yin yang) with a print resolution of 220 dpi over a 30% region of the surface thereof. The printed image had a sharp contour, and this remained even after storage.

What is claimed is:

1. A washing agent tablet having a printable phase made of a compressed particulate premixture, wherein
the particulate premixture has a particle size distribution in which at least 60 wt. % of the particles have a particle size between 100 μm and 900 μm;
at least 90% of a surface of the printable phase outside a printed region has a degree of whiteness which is defined by
L*ₘₐₓ is in the range of from 85 to 100,
a*ₘₐₓ is in the range of from −3 to +5,
b*ₘₐₓ is in the range of from +5 to −15.

2. The washing agent tablet according to claim 1, wherein the particulate premixture has a particle size distribution in which at least 70 wt. % of the particles have a particle size between 100 μm and 900 μm.

3. The washing agent tablet according to claim 1, wherein the particulate premixture has a particle size distribution in which at least 60 wt. % of the particles have a particle size between 200 μm and 800 μm.

4. The washing agent tablet according to claim 1, wherein the particulate premixture has a particle size distribution in which at least 60 wt. % of the particles have a particle size between 250 μm and 750 μm.

5. The washing agent tablet according to claim 1, wherein the washing agent tablet has two layers.

6. The washing agent tablet according to claim 1, wherein the washing agent tablet has two layers which differ with respect to their average particle size D50, and the layer having the lower average particle size D50 has a printed portion.

7. The washing agent tablet according to claim 1, wherein the washing agent tablet has two layers which differ with respect to their whiteness, and the layer having the higher degree of whiteness has a printed portion.

8. The washing agent tablet according to claim 1, wherein the washing agent tablet comprises at least one active ingredient of builders selected from the group consisting of zeolites, silicates and carbonates.

9. The washing agent tablet according to claim 1, wherein the washing agent tablet comprises at least one active ingredient selected from the group consisting of celluloses, cellulose derivatives, microcrystalline celluloses and carboxymethyl celluloses.

10. The washing agent tablet according to claim 1, wherein the washing agent tablet, based on the total weight thereof, contains less than 10 wt. % of an organic acid.

11. A method for producing a printed washing agent tablet comprising the steps of:
a) providing a particulate premixture, wherein the particulate premixture has a particle size distribution in which at least 60 wt. % of the particles have a particle size between 100 μm and 900 μm,
b) pressing the particulate premixture to form a washing agent tablet, and
c) printing the resulting washing agent tablet, wherein at least 90% of a surface of a printable phase outside the printed region has a degree of whiteness which is defined by
L*ₘₐₓ is in the range of from 85 to 100,
a*ₘₐₓ is in the range of from −3 to +5,
b*ₘₐₓ is in the range of from +5 to −15.
